(19) United States
(12) Patent Application Publication
(10) Pub. No.: US 2006/0020975 A1
(43) Pub. Date: Jan. 26, 2006

(54) System and method for propagating satellite TV-band, cable TV-band, and data signals over an optical network

(75) Inventors: John J. Kenny, Suwanee, GA (US); Paul F. Whittlesey, Sugar Hill, GA (US); James O. Farmer, Cumming, GA (US)

Correspondence Address: Steven P. Wigmore, Esq.;KING & SPALDING LLP, 45th Floor, 191 Peachtree Street, Atlanta, GA, 30303-1763, US

(73) Assignee: Wave7 Optics, Inc., Alpharetta, GA (US)

(21) Appl. No.: 11/173,940

(22) Filed: Jul. 1, 2005

Related U.S. Application Data
(63) Continuation-in-part of application No. 09/899,410, filed on Jul. 5, 2001, now Pat. No. 6,973,271.
(60) Provisional application No. 60/584,957, filed on Jul. 2, 2004.

(51) Int. Cl. H04N 7/20; H04N 7/173

(52) U.S. Cl. 725/63; 725/129; 725/126

(57) ABSTRACT

An optical network can include a data service hub, a laser transceiver node, and a subscriber optical interface. The data service hub can comprise a satellite antenna and a RF receiver for receiving satellite TV-band electrical signals. These electrical signals can be converted into the optical domain and then propagated over the optical network through optical waveguides to the subscriber optical interface. The subscriber optical interface can comprise an optical filter and a satellite analog optical receiver. The optical filter can separate the satellite TV-band optical signals having a first optical wavelength from other optical signals such as cable TV-band optical signals with a second optical wavelength and data optical signals with a third optical wavelength. The satellite analog optical receiver can further comprise various mechanisms for controlling access to the satellite TV-band signals.

### PRIORITY CLAIM TO PROVISIONAL AND NON-PROVISIONAL APPLICATIONS

The present application claims priority to provisional patent application entitled, “METHOD FOR RECEIVING SATELLITE-BAND OR CABLE-TV BAND SIGNALS IN AN OPTICAL NETWORK,” filed on Jul. 2, 2004 and assigned U.S. application Ser. No. 60/584,957; the entire contents of which are hereby incorporated by reference. The present application also claims priority to Non-provisional patent application entitled, “SYSTEM AND METHOD FOR COMMUNICATING OPTICAL SIGNALS BETWEEN A DATA SERVICE PROVIDER AND SUBSCRIBERS,” filed on Jul. 5, 2001 and assigned U.S. application Ser. No. 09/899,410; the entire contents of which are incorporated by reference.

### TECHNICAL FIELD

The invention relates to video, voice, and data communications. More particularly, the invention relates to a system and method for communicating satellite TV-band or cable-TV band (or both) signals and data signals from a data service provider to one or more subscribers.

### BACKGROUND OF THE INVENTION

The increasing reliance on communication networks to transmit more complex data, such as voice and video traffic, is causing a very high demand for bandwidth. To resolve this demand for bandwidth, communication networks are relying more upon optical fibers to transmit this complex data. Conventional communication architectures that employ coaxial cables are slowly being replaced with communication networks that comprise only fiber optic cables. One advantage that optical fibers have over coaxial cables is that a much greater amount of information can be carried on an optical fiber.

The Fiber-to-the-home (FTTH) optical network architecture has been a dream of many data service providers because of the aforementioned capacity of optical fibers that enable the delivery of any mix of high-speed services to businesses and consumers over highly reliable networks. Related to FTTH is fiber to the business (FTTB). FTTH and FTTB architectures are desirable because of improved signal quality, lower maintenance, and longer life of the hardware involved with such systems. However, in the past, the cost of FTTH and FTTB architectures have been considered prohibitive. But now, because of the high demand for bandwidth and the current research and development of improved optical networks, FTTH and FTTB have become a reality.

While costs have generally declined for FTTH and FTTB architectures, small scale operators of FTTH and FTTB architectures usually find that the cost associated with hardware needed to support cable TV-band video programming over the FTTH/FTTB optical networks can be an impediment to enter the market. A significant amount of equipment ranging from modulators to RF combiners is usually needed to support the propagation of cable-TV band video programming over the optical network. Small scale FTTH/FTTB operators, such as apartment buildings, have a need for a low-cost alternative that call allow an operator to provide video TV services to its subscribers without significant equipment and expense.

Another related need exists for subscribers in apartment buildings who desire to receive satellite TV-band video programming instead of cable TV-band video programming. For those subscribers on a north side of an apartment building, they are usually unable to receive satellite TV-band signals because most satellite TV-band signals are transmitted to the earth by satellites orbiting at the equator, so that in the northern hemisphere, the receiving antenna (“dish”) must face southward. In other words, the north side of a building cannot receive satellite signals because its satellite dish antennas would be unable to “see” or be positioned in a manner to have a direct line of sight with the satellites that are transmitting satellite TV-band signals to the earth.

Another problem exists for the small scale FTTH/FTTB operator who desires to offer video services from both cable TV-band suppliers and satellite TV-band suppliers. Many conventional FTTH and FTTB architectures are designed only for cable TV-band applications. Many conventional FTTH and FTTB architectures have not contemplated supporting video services originating from either cable TV-bands or satellite TV-bands or both.

As background, satellite TV-band signals can usually originate from a dish antenna and are directed to earth orbiting satellites. The satellites receive and re-transmit to the satellite TV-band signals back down to satellite receivers with dish antennas located on earth. The satellite TV-band signals are generally transmitted to earth in a 12 GHz frequency range. Typically, at the receiving antenna, the signals are converted to a 950 to 1450 MHz range, and in some cases will be converted to frequencies as high as about 3 GHz. Satellite TV-band signals typically includes only subscription type TV programming.

Meanwhile, cable TV-band signals usually originate from a facility referred to in the industry as a head-end (also referred to as a data service hub in this document) and can be transmitted over a wire such a coaxial cable in generally the 50 MHz to 870 MHz frequency range. Cable TV-band signals can include those television signals that designed for reception by conventional RF receivers. Cable TV-band signals can include both public and subscription type TV programming.

In light of the above discussion of the state of the conventional art, there is a need for a system and method for efficiently propagating satellite TV-band signals over an entirely optical network. There is also a need in the art for a system and method that can support the propagation of both satellite TV-band and cable-TV band signals over an optical network. Further, a need exists in the art for an optical network that can support cable TV-band signals, satellite TV-band signals, as well as data signals. Another need exists in the art for an optical network system that can efficiently control access to the various TV services offered to its subscribers such as either cable TV-band signals or satellite TV-band signals. Yet another need in the art exists for an optical network system that can support multiple satellite TV-band signals from multiple satellite receivers in addition to supporting satellite TV-band signals that are transmitted using two or more polarizations.

### SUMMARY OF THE INVENTION

The invention is a system and method for efficient propagation of data, cable television (TV)-band signals, and satellite TV-band signals over an optical fiber network. The system can permit a subscriber to receive both cable TV-band signals and satellite TV-band signals or either type. The system can permit small scale organizations, such as an apartment building with multiple subscribers, to offer data services and TV services in a very cost efficient manner.

Specifically, a small scale organization can provide data services with appropriate computer hardware and TV services with a satellite antenna and receiver. In this way, the small scale organization can offer TV services to its subscribers without the need for a wired connection to a larger TV service provider such as a cable TV-band supplier or head end operator. The method and system can also eliminate the need for a small scale organization to provide its own costly head-end cable TV-band equipment if the small scale organization intends to operate independently of other cable TV-band suppliers.

Other exemplary aspects of the inventive system and method can include offering multiple different TV services from many different satellite TV-band antennas and receivers. One additional exemplary aspect can include offering both cable TV-band and satellite TV-band signals to subscribers in addition to data services over a single optical network.

The system, according to one exemplary embodiment, can include a data service hub that comprises a satellite TV-band antenna and receiver. The data service hub can also include a optical transmitter for converting the satellite TV-band signals from the electrical domain into the optical domain at a first optical wavelength. The data service hub can also include a optical combiner or coupler that can combine optical signals of a second optical wavelength originating from either a cable TV-band head end or another satellite TV-band receiver. The combined optical signals can be propagated over a single optical waveguide from the data service hub to a laser transceiver node.

In the laser transceiver node, the combined TV optical signals can be further combined or mixed with optical signals of a third wavelength that comprise data signals. The combined TV and data optical signals can be further propagated over a single optical waveguide to a subscriber optical interface.

The subscriber optical interface can comprise an optical filter and a satellite analog optical receiver. The optical filter can separate the combined optical signals into the three original optical signals having the first, second and third optical wavelengths. The satellite analog optical receiver can receive the satellite TV-band optical signals with the first optical wavelength from the optical filter and it can convert the satellite TV-band optical signals into the electrical domain so that a satellite RF receiver can further process the electrical signals for a TV.

The satellite analog optical receiver can also be designed to handle multiple frequency bands if received satellite TV-band signals are being transmitted using two polarizations. According to an exemplary aspect, the satellite analog optical receiver can comprise a selector switch for selecting between two signals in the same frequency band that are used to support two or more polarizations of satellite TV-band signals.

The method and system can further include various ways to monitor and control access to the satellite TV-band services by a subscriber. According to one exemplary aspect, a service disconnect switch that can be turned “off” and “on” with a two-level voltage can be housed within the subscriber optical interface. The two-level voltage can be controlled by signals from the data service hub.

According to another exemplary aspect, a serial data communications line can be used to operate the service disconnect switch in which the serial data communications line can be plugged into a data interface that is already part of the subscriber optical interface. In this way, the serial data communications line can comprise an Ethernet connection to the data interface. The serial data communications line can be designed to monitor for a “keep alive” signal on a periodic basis.

According to another aspect, a service disconnect switch can be controlled by a separate RF carrier that is demodulated by a special receiver coupled to the service disconnect switch. Each special receiver of a subscriber optical interface can be assigned a unique address.

### BRIEF DESCRIPTION OF THE DRAWINGS

FIG. 1 is a functional block diagram of some core components of an exemplary optical network architecture according to the invention.

FIG. 2 is a functional block diagram illustrating an exemplary optical network architecture for the invention.

FIG. 3 is a functional block diagram illustrating an exemplary data service hub of the invention.

FIG. 4 is a functional block diagram illustrating an exemplary outdoor laser transceiver node according to the invention.

FIG. 5 is a functional block diagram illustrating an optical tap connected to a subscriber interface having an optical filter and satellite receiver by a single optical waveguide according to one exemplary embodiment of the invention.

FIG. 6A is a functional block diagram illustrating an exemplary optical filter according to an exemplary embodiment of the invention.

FIG. 6B is an exemplary performance graph of optical wavelength versus response for the optical filter illustrated in FIG. 6A.

FIG. 7A is a functional block diagram illustrating an exemplary satellite analog optical receiver with a large frequency passband with two optional service controls according to an exemplary embodiment of the invention.

FIG. 7B is a functional block diagram illustrating an exemplary satellite analog optical receiver with two optional service controls in addition to a polarization switch according to an alternate exemplary embodiment of the invention.

FIG. 8A is a functional block diagram illustrating an alternate exemplary embodiment of a portion of a data service hub in which two or more satellite RF receivers are used to generate two sets of optical signals of different wavelengths that can be combined with cable TV-band signals at another wavelength.

FIG. 8B is a functional block diagram illustrating two polarities of satellite signals being received from a single dish antenna according to an alternate exemplary embodiment of the invention.

FIG. 9 is a logic flow diagram illustrating an exemplary method for providing satellite TV-band video services over an optical network according to one exemplary embodiment of the invention.

### DETAILED DESCRIPTION OF EXEMPLARY EMBODIMENTS

The invention may be embodied in hardware or software or a combination thereof disposed within an optical network. The optical network can include a data service hub, a laser transceiver node, and a subscriber optical interface. The data service hub can comprise a satellite antenna and a RF receiver for receiving satellite TV-band electrical signals. These electrical signals can be converted into the optical domain and then propagated over the optical network through optical waveguides to the subscriber optical interface. The subscriber optical interface can comprise an optical filter and a satellite analog optical receiver. The optical filter can separate the satellite TV-band optical signals having a first optical wavelength from other optical signals such as cable TV-band optical signals with a second optical wavelength and data optical signals with a third optical wavelength.

The satellite analog optical receiver can comprise a selector switch for selecting between two frequency bands that are used to support two or more polarizations of satellite TV-band signals. The satellite analog optical receiver can further comprise various mechanisms for controlling access to the satellite TV-band signals.

Referring now to the drawings, in which like numerals represent like elements throughout the several Figures, aspects of the invention and the illustrative operating environment will be described.

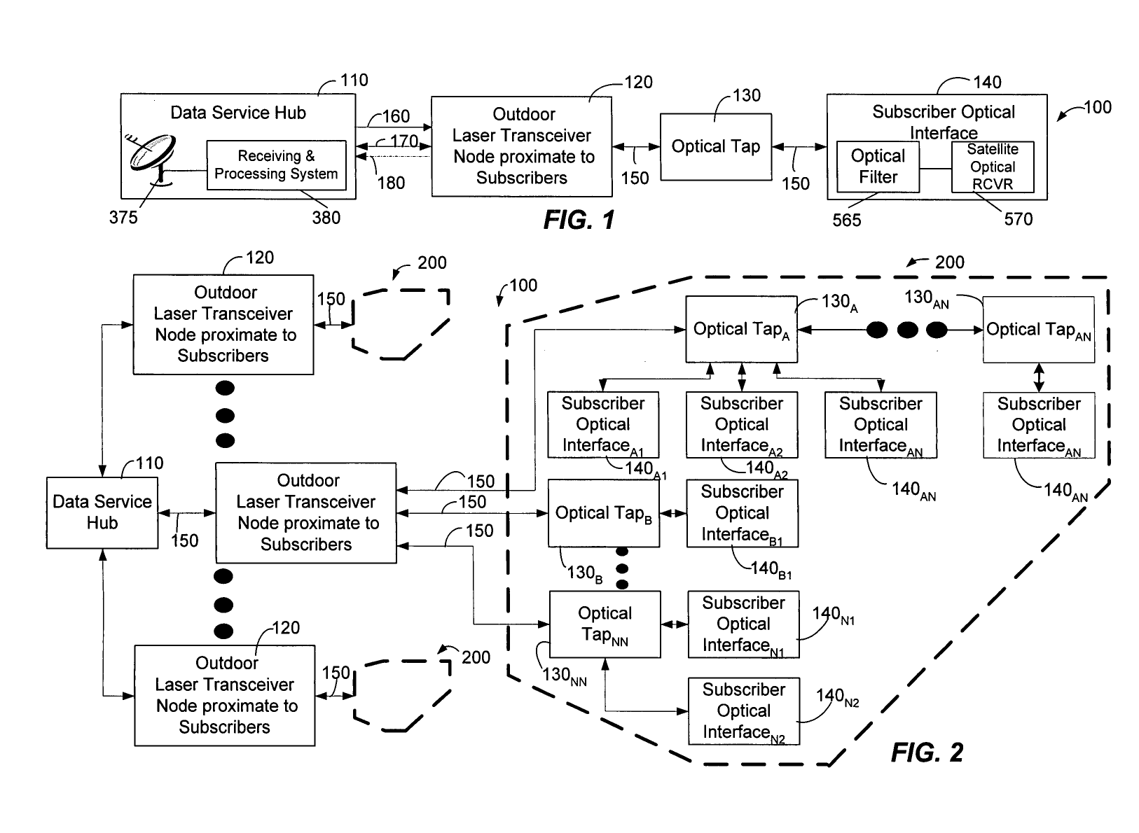

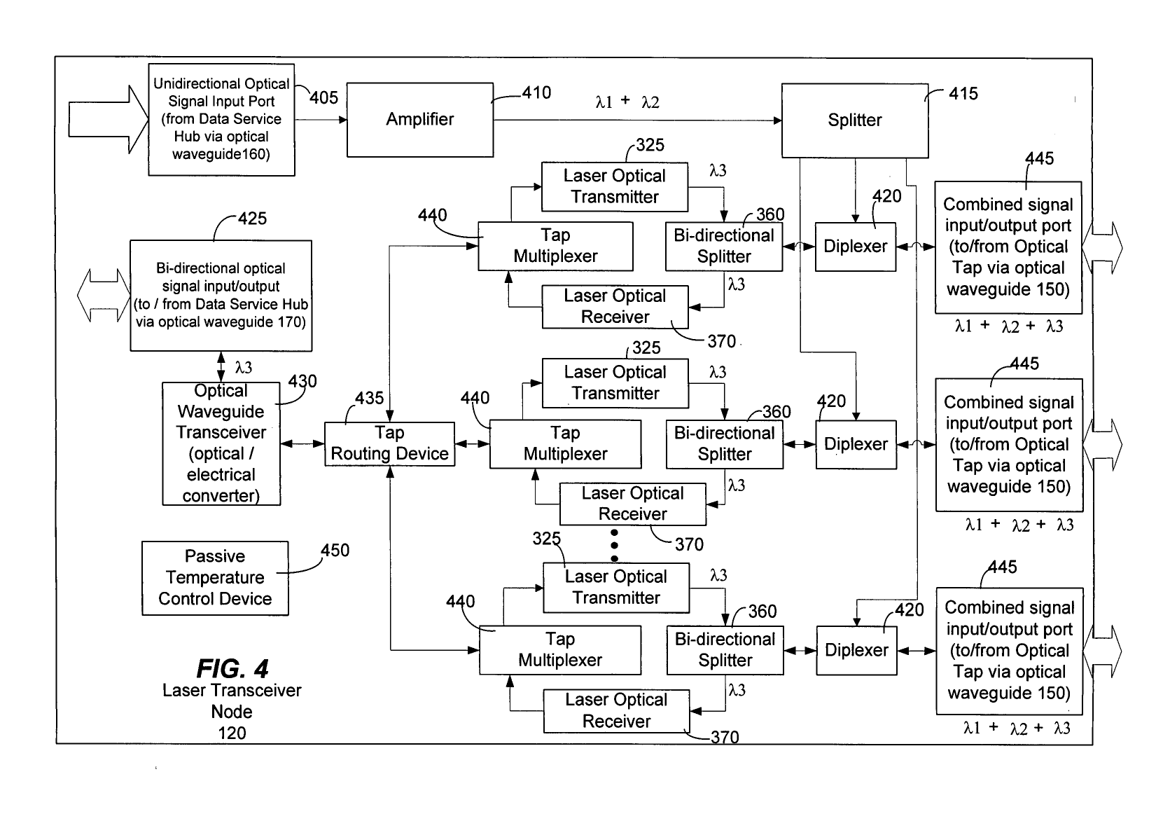

FIG. 1 is a functional block diagram illustrating an exemplary optical network architecture 100 according to the invention. The exemplary optical network architecture 100 comprises a data service hub 110 that is connected to outdoor laser transceiver nodes 120. The data service hub can comprise a satellite antenna 375 and a satellite receiving and L-band processing system 380. The satellite antenna 375 and satellite receiving and L-band processing system will be described in further detail below in connection with FIG. 3.

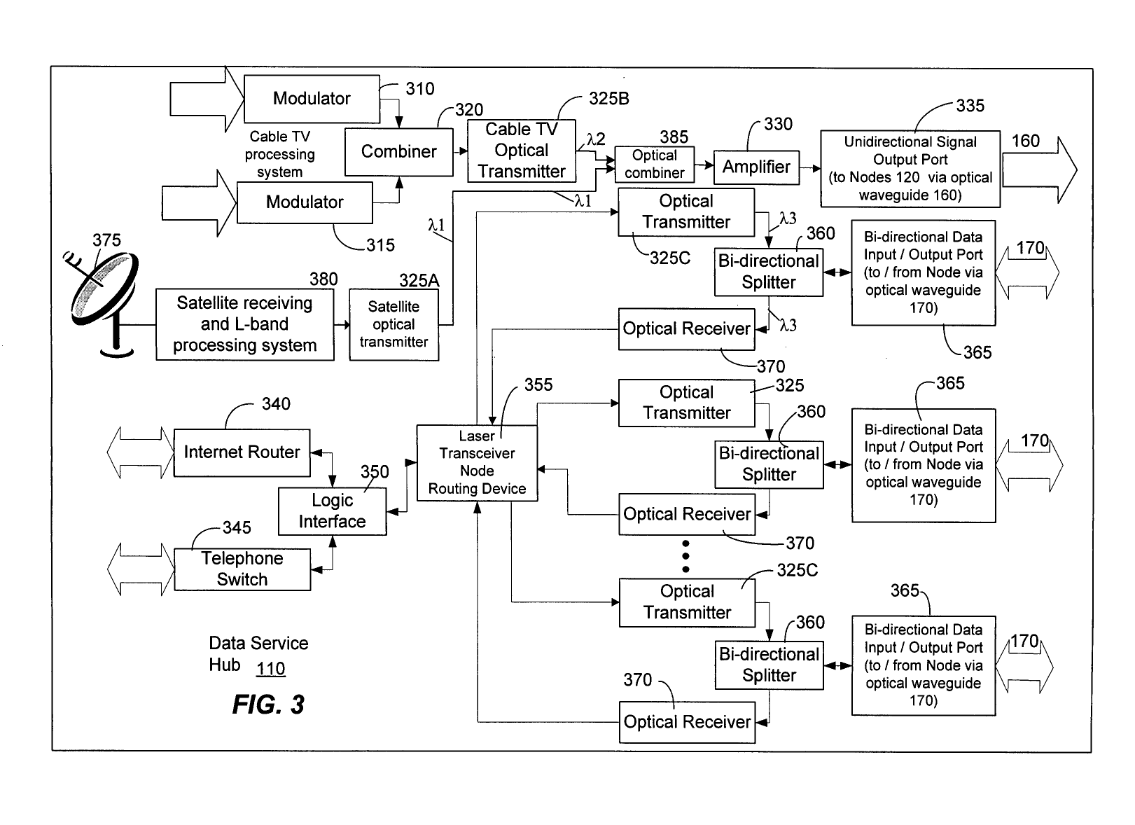

The laser transceiver nodes 120 are connected to optical taps 130. The optical taps 130 can be connected to a plurality of subscriber optical interfaces 140. Between respective components of the exemplary optical network architecture 100 are optical waveguides such as optical waveguides 150, 160, 170, and 180. The optical waveguides 150-180 are illustrated by arrows where the arrowheads of the arrows illustrate exemplary directions of data flow between respective components of the illustrative and exemplary optical network architecture 100. While only an individual laser transceiver node 120, an individual optical tap 130, and an individual subscriber optical interface 140 are illustrated in FIG. 1, as will become apparent from FIG. 2 and its corresponding description, a plurality of laser transceiver nodes 120, optical taps 130, and subscriber optical interfaces 140 can be employed without departing from the scope and spirit of the invention. Typically, in many of the exemplary embodiments of the invention, multiple subscriber optical interfaces 140 are connected to one or more optical taps 130.

The outdoor laser transceiver node 120 can allocate additional or reduced bandwidth based upon the demand of one or more subscribers that use the subscriber optical interfaces 140. The outdoor laser transceiver node 120 can be designed to withstand outdoor environmental conditions and can be designed to hang on a strand or fit in a pedestal or “hand hole” The outdoor laser transceiver node can operate in a temperature range between minus 40 degrees Celsius to plus 60 degrees Celsius. The laser transceiver node 120 can operate in this temperature range by using passive cooling devices that do not consume power.

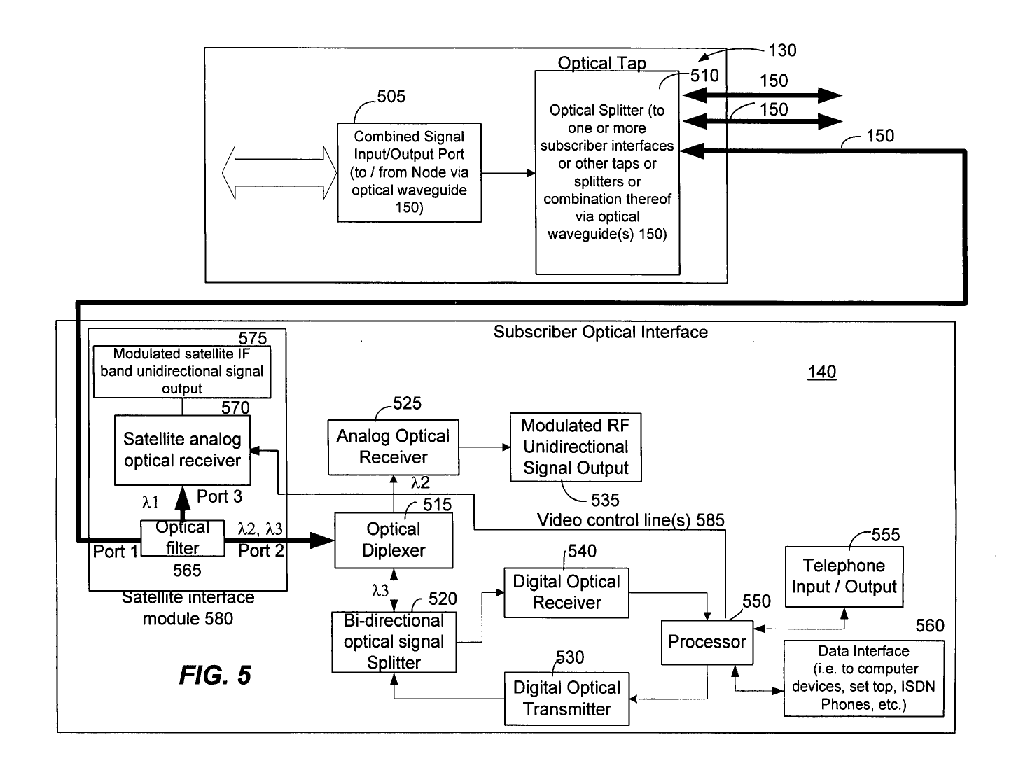

Unlike the conventional routers disposed between the subscriber optical interface 140 and data service hub 110, the outdoor laser transceiver node 120 does not require active cooling and heating devices that control the temperature surrounding the laser transceiver node 120. The invention attempts to place more of the decision-making electronics at the data service hub 110 instead of the laser transceiver node 120. Typically, the decision-making electronics are larger in size and produce more heat than the electronics placed in the laser transceiver node of the invention. Because the laser transceiver node 120 does not require active temperature controlling devices, the laser transceiver node 120 lends itself to a compact electronic packaging volume that is typically smaller than the environmental enclosures of conventional routers. Further details of the components that make up the laser transceiver node 120 will be discussed in further detail below with respect to FIG. 4.

In one exemplary embodiment of the invention, three trunk optical waveguides 160, 170, and 180 (that can comprise optical fibers) can conduct optical signals from the data service hub 110 to the outdoor laser transceiver node 120. It is noted that the term “optical waveguide” used in the present application can apply to optical fibers, planar light guide circuits, and fiber optic pigtails and other like optical waveguides.

A first optical waveguide 160 can carry broadcast video that can include cable TV-band and satellite TV-band signals. The cable TV-band signals can be carried in a traditional cable television format wherein the broadcast signals are modulated onto carriers, which in turn, modulate an optical transmitter (not shown in FIG. 1, but see FIG. 3) in the data service hub 110. Similarly, satellite TV-band signals can be modulated onto carriers that modulate another optical transmitter. A second optical waveguide 170 can carry downstream targeted services such as data and telephone services to be delivered to one or more subscriber optical interfaces 140. In addition to carrying subscriber-specific optical signals, the second optical waveguide 170 can also propagate internet protocol broadcast packets, as is understood by those skilled in the art.

In one exemplary embodiment, a third optical waveguide 180 can transport data signals upstream from the outdoor laser transceiver node 120 to the data service hub 110. The optical signals propagated along the third optical waveguide 180 can also comprise data and telephone services received from one or more subscribers. Similar to the second optical waveguide 170, the third optical waveguide 180 can also carry IP broadcast packets, as is understood by those skilled in the art.

The third or upstream optical waveguide 180 is illustrated with dashed lines to indicate that it is merely an option or part of one exemplary embodiment according to the invention. In other words, the third optical waveguide 180 can be removed. In another exemplary embodiment, the second optical waveguide 170 propagates optical signals in both the upstream and downstream directions as is illustrated by the double arrows depicting the second optical waveguide 170. In such an exemplary embodiment where the second optical waveguide 170 propagates bidirectional optical signals, only two optical waveguides 160, 170 would be needed to support the optical signals propagating between the data server's hub 110 in the outdoor laser transceiver node 120. In another exemplary embodiment (not shown), a single optical waveguide can be the only link between the data service hub 110 and the laser transceiver node 120. In such a single optical waveguide embodiment, three different wavelengths can be used for the upstream and downstream signals. Alternatively, bi-directional data could be modulated on one wavelength.

In one exemplary embodiment, the optical tap 130 can comprise an 8-way optical splitter. This means that the optical tap 130 comprising an 8-way optical splitter can divide downstream optical signals eight ways to serve eight different subscriber optical interfaces 140. In the upstream direction, the optical tap 130 can combine the optical signals having a third wavelength λ3 received from the eight subscriber optical interfaces 140.

In another exemplary embodiment, the optical tap 130 can comprise a 4-way splitter to service four subscriber optical interfaces 140. Yet in another exemplary embodiment, the optical tap 130 can further comprise a 4-way splitter that is also a pass-through tap meaning that a portion of the optical signal received at the optical tap 130 can be extracted to serve the 4-way splitter contained therein while the remaining optical energy is propagated further downstream to another optical tap or another subscriber optical interface 140. The invention is not limited to 4-way and 8-way optical splitters. Other optical taps having fewer or more than 4-way or 8-way splits are not beyond the scope of the invention.

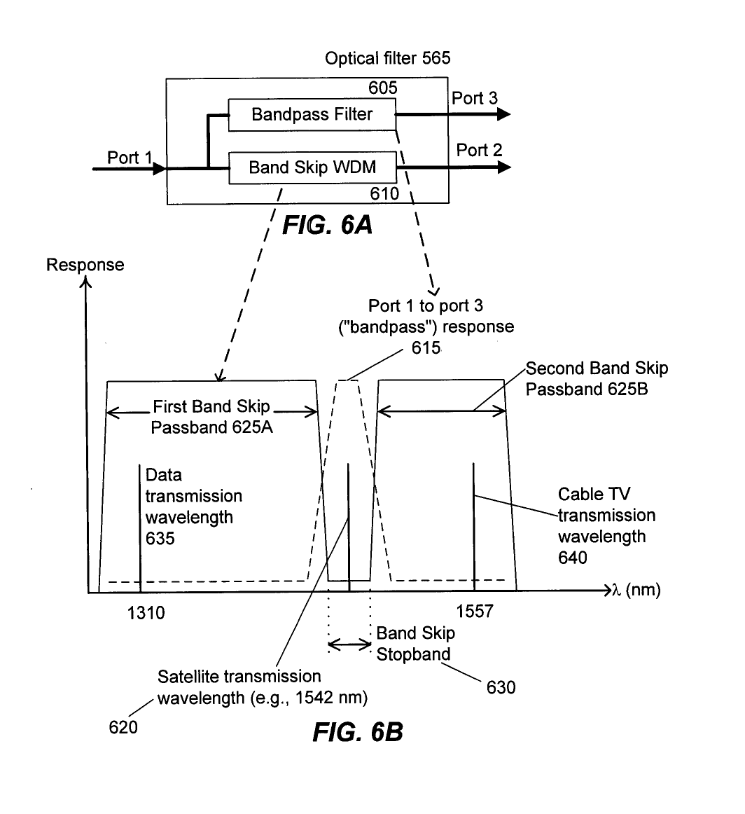

The subscriber optical interface 140 can comprise an optical filter 565 and an analog satellite optical receiver 570. The optical filter 565 and the analog satellite optical receiver 570 will be discussed in further detail below with respect to FIG. 5.

Referring now to FIG. 2, this Figure is a functional block diagram illustrating an exemplary optical network architecture 100 that further includes subscriber groupings 200 that correspond with a respective outdoor laser transceiver node 120. FIG. 2 illustrates the diversity of the exemplary optical network architecture 100 where a number of optical waveguides 150 connected between the outdoor laser transceiver node 120 and the optical taps 130 is minimized. FIG. 2 also illustrates the diversity of subscriber groupings 200 that can be achieved with the optical tap 130.

Each optical tap 130 can comprise an optical splitter. The optical tap 130 allows multiple subscriber optical interfaces 140 to be coupled to a single optical waveguide 150 that is connected to the outdoor laser transceiver node 120. In one exemplary embodiment, six optical fibers 150 are designed to be connected to the outdoor laser transceiver node 120. Through the use of the optical taps 130, sixteen subscribers can be assigned to each of the six optical fibers 150 that are connected to the outdoor laser transceiver node 120.

In another exemplary embodiment, twelve optical fibers 150 can be connected to the outdoor laser transceiver node 120 while eight subscriber optical interfaces 140 are assigned to each of the twelve optical fibers 150. Those skilled in the art will appreciate that the number of subscriber optical interfaces 140 assigned to a particular waveguide 150 that is connected between the outdoor laser transceiver node 120 and a subscriber optical interface 140 (by way of the optical tap 130) can be varied or changed without departing from the scope and spirit of the invention. Further, those skilled in the art recognize that the actual number of subscriber optical interfaces 140 assigned to the particular fiber optic cable is dependent upon the amount of power available on a particular optical fiber 150.

As depicted in subscriber grouping 200, many configurations for supplying communication services to subscribers are possible. For example, while optical tap 130_{A} can connect subscriber optical interfaces 140_{A1} through subscriber optical interface 140_{AN} to the outdoor laser transmitter node 120, optical tap 130_{A} can also connect other optical taps 130 such as optical tap 130_{AN} to the laser transceiver node 120. The combinations of optical taps 130 with other optical taps 130 in addition to combinations of optical taps 130 with subscriber optical interfaces 140 are limitless. With the optical taps 130, concentrations of distribution optical waveguides 150 at the laser transceiver node 120 can be reduced. Additionally, the total amount of fiber needed to service a subscriber grouping 200 can also be reduced.

With the active laser transceiver node 120 of the invention, the distance between the laser transceiver node 120 and the data service hub 110 can comprise a range between 0 and 80 kilometers. However, the invention is not limited to this range. Those skilled in the art will appreciate that this range can be expanded by selecting various off-the-shelf components that make up several of the devices of the present system.

Those skilled in the art will appreciate that other configurations of the optical waveguides disposed between the data service hub 110 and outdoor laser transceiver node 120 are not beyond the scope of the invention. Because of the bi-directional capability of optical waveguides, variations in the number and directional flow of the optical waveguides disposed between the data service hub 110 and the outdoor laser transceiver node 120 can be made without departing from the scope and spirit of the invention.

Referring now to FIG. 3, this functional block diagram illustrates an exemplary data service hub 110 according to one exemplary embodiment of the invention. The exemplary data service hub 110 illustrated in FIG. 3 is designed for a two trunk optical waveguide system. That is, this data service hub 110 of FIG. 3 is designed to send and receive optical signals to and from the outdoor laser transceiver node 120 along the first optical waveguide 160 and the second optical waveguide 170. With this exemplary embodiment, the second optical waveguide 170 supports bi-directional data flow. In this way, the third optical waveguide 180 discussed above is not needed.

The data service hub 110 can comprise a satellite antenna 375 and a satellite receiving and L-band processing system 380. While a dish-type antenna 375 is illustrated in FIG. 3 that comprises a parabolic reflector and an antenna element located at the focal point of the reflector, those skilled in the art will appreciate that other satellite antennas, such as patch-array, monopole, and other like antennas are not beyond the scope and spirit of the invention.

In the satellite receiving and processing system 380 that is coupled to the satellite antenna 380, the nomenclature of “L-band” generally refers to the intermediate frequency range used in conventional down-linking direct broadcast satellite signals. However, the invention is not limited to this frequency band and direct broadcast satellite signals. Other satellite frequency bands and satellite signals are not beyond the scope of the invention.

According to one exemplary embodiment, the signals originate from a satellite in a frequency in the range of 12 GHz. The signals are usually converted to the frequency band of between approximately 950 and 2150 MHz at the satellite antenna 375, and then they are converted further in the satellite receiving and processing system 380. The 950 to 2150 MHz frequency band is typically referred to as the L-band by those of ordinary skill in the art.

The satellite receiving and L-band processing system 380 can amplify the converted satellite TV-band signals. The process of converting high frequency satellite signals from the 12 GHz frequency range to the lower L-band frequency range of 950 to 2150 MHz are well known to those skilled in the art.

The data service hub 110 further includes an optical transmitter 325A that converts the electrical RF satellite TV-band signals into the optical domain. The satellite TV-band optical signals can be transmitted on a first optical wavelength λ1. By way of example, the first optical wavelength λ1 can comprise a wavelength of approximately 1542 nm. However, other optical wavelengths are not beyond the scope of the invention.

The data service hub 110 can further comprise one or more modulators 310, 315 that are designed to support television broadcast services such as cable TV-band signals. The one or more modulators 310, 315 can be analog or digital type modulators. In one exemplary embodiment, there can be at least 78 modulators present in the data service hub 110. Those skilled in the art will appreciate that the number of modulators 310, 315 can be varied without departing from the scope and spirit of the invention.

The signals from the modulators 310, 315 are combined in an RF combiner 320 where they are supplied to a cable TV-band optical transmitter 325B where the radio frequency signals generated by the modulators 310, 315 are converted into optical form at a second optical wavelength λ2. By way of example, the second optical wavelength λ2 can comprise a wavelength of approximately 1557 nm.

The cable TV-band optical transmitter 325B as well as the satellite optical transmitter 325A can comprise one of Fabry-Perot (F-P) Laser Transmitters, distributed feedback lasers (DFBs), or Vertical Cavity Surface Emitting Lasers (VCSELs). However, other types of optical transmitters are possible and are not beyond the scope of the invention. With the aforementioned optical transmitters 325, the data service hub 110 lends itself to efficient upgrading by using off-the-shelf hardware to generate optical signals.

The optical signals having the first optical wavelength of λ1 generated by the satellite TV-band optical transmitter 325A and the optical signals having the second optical wavelength of λ2 generated by the cable TV-band optical transmitter 325B (later referred to as the unidirectional optical signals) can be combined in an optical combiner 385. The combined TV optical signals are then propagated to amplifier 330 such as an Erbium Doped Fiber Amplifier (EDFA) where the unidirectional optical signals are amplified. The amplified unidirectional optical signals are then propagated out of the data service hub 110 via a unidirectional signal output port 335 which is connected to one or more first optical waveguides 160.

The unidirectional signal output port 335 is connected to one or more first optical waveguides 160 that support unidirectional optical signals originating from the data service hub 110 to a respective laser transceiver node 120. The data service hub 110 illustrated in FIG. 3 can further comprise an Internet router 340. The data service hub 110 can further comprise a telephone switch 345 that supports telephony service to the subscribers of the optical network system 100. However, other telephony service such as Internet Protocol telephony can be supported by the data service hub 110. If only Internet Protocol telephony is supported by the data service hub 110, then it is apparent to those skilled in the art that the telephone switch 345 could be eliminated in favor of lower cost VoIP equipment. For example, in another exemplary embodiment (not shown), the telephone switch 345 could be substituted with other telephone interface devices such as a soft switch and gateway. But if the telephone switch 345 is needed, it may be located remotely from the data service hub 110 and can be connected through any of several conventional means of interconnection.

The data service hub 110 can further comprise a logic interface 350 that is connected to a laser transceiver node routing device 355. The logic interface 350 can comprise a Voice over Internet Protocol (VoIP) gateway when required to support such a service. The laser transceiver node routing device 355 can comprise a conventional router that supports an interface protocol for communicating with one or more laser transceiver nodes 120. This interface protocol can comprise one of gigabit or faster Ethernet, Internet Protocol (IP) or SONET protocols. However, the invention is not limited to these protocols. Other protocols can be used without departing from the scope and spirit of the invention.

The logic interface 350 and laser transceiver node routing device 355 can read packet headers originating from the laser transceiver nodes 120 and the internet router 340. The logic interface 350 can also translate interfaces with the telephone switch 345. After reading the packet headers, the logic interface 350 and laser transceiver node routing device 355 can determine where to send the packets of information.

The laser transceiver node routing device 355 can supply downstream data signals to respective optical transmitters 325C. The optical transmitters 325C can convert the electrical data signals into the optical domain at a third optical wavelength of λ3. By way of example, the third optical wavelength λ3 can comprise a wavelength of approximately 1310 or 1550 nm. However, other optical wavelengths are not beyond the scope of the invention.

The data signals converted by the optical transmitters 325C can then be propagated to a bi-directional splitter 360. The optical signals sent from the optical transmitter 325C into the bi-directional splitter 360 can then be propagated towards a bi-directional data input/output port 365 that is connected to a second optical waveguide 170 that supports bi-directional optical data signals between the data service hub 110 and a respective laser transceiver node 120.

Upstream optical signals, also comprising the third wavelength λ3, received from a respective laser transceiver node 120 can be fed into the bidirectional data input/output port 365 where the optical signals are then forwarded to the bi-directional splitter 360. From the bi-directional splitter 360, respective optical receivers 370 can convert the upstream optical signals into the electrical domain. The upstream electrical signals generated by respective optical receivers 370 are then fed into the laser transceiver node routing device 355. Each optical receiver 370 can comprise one or more photoreceptors or photodiodes that convert optical signals into electrical signals.

When distances between the data service hub 110 and respective laser transceiver nodes 120 are modest, the optical transmitters 325C can propagate optical signals at 1310 mn. But where distances between the data service hub 110 and the laser transceiver node are more extreme, the optical transmitters 325 can propagate the optical signals at wavelengths of 1550 nm with or without appropriate amplification devices.

Those skilled in the art will appreciate that the selection of optical transmitters 325C for each circuit may be optimized for the optical path lengths needed between the data service hub 110 and the outdoor laser transceiver node 120. Further, those skilled in the art will appreciate that the wavelengths discussed are practical but are only illustrative in nature. In some scenarios, it may be possible to use communication windows at 1310 and 1550 nm in different ways without departing from the scope and spirit of the invention. Further, the invention is not limited to a 1310 and 1550 nm wavelength regions. Those skilled in the art will appreciate that smaller or larger wavelengths for all of the optical signals, that is, for the data, cable TV-band, and satellite TV-band optical signals, are not beyond the scope and spirit of the invention.

Referring now to FIG. 4, this Figure illustrates a functional block diagram of an exemplary outdoor laser transceiver node 120 of the invention. In this exemplary embodiment, the laser transceiver node 120 can comprise a unidirectional optical signal input port 405 that can receive optical signals propagated from the data service hub 110 that are propagated along a first optical waveguide 160. The optical signals received at the unidirectional optical signal input port 405 can comprise broadcast video data from both the cable TV-band and the satellite TV-band, which signals are on different optical wavelengths. The optical signals received at the input port 405 are propagated to an amplifier 410 such as an Erbium Doped Fiber Amplifier (EDFA) in which the optical signals are amplified. The amplified optical signals are then propagated to a splitter 415 that divides the broadcast video optical signals among diplexers 420 that are designed to forward optical signals to predetermined subscriber groups 200.

The laser transceiver node 120 can further comprise a bi-directional optical signal input/output port 425 that connects the laser transceiver node 120 to a second optical waveguide 170 that supports bidirectional data flow between the data service hub 110 and laser transceiver node 120. Downstream optical signals at the third wavelength of λ3 flow through the bidirectional optical signal input/output port 425 to an optical waveguide transceiver 430 that converts downstream optical signals into the electrical domain. The optical waveguide transceiver 430 further converts upstream electrical signals into the optical domain. The optical waveguide transceiver 430 can comprise an optical/electrical converter and an electrical/optical converter.

Downstream and upstream electrical signals are communicated between the optical waveguide transceiver 430 and a tap routing device 435. The tap routing device 435 can manage the interface with the data service hub optical signals and can route or divide or apportion the data service hub signals according to individual tap multiplexers 440 that communicate optical signals with one or more optical taps 130 and ultimately one or more subscriber optical interfaces 140. It is noted that tap multiplexers 440 operate in the electrical domain to modulate laser transmitters 325 in order to generate optical signals having the third wavelength of λ3 that are assigned to groups of subscribers coupled to one or more optical taps. It is noted that in some embodiments, a fourth wavelength λ4 could exist on one side of the laser transceiver node 120. This fourth wavelength would have a magnitude that is different from the first, second, and third wavelengths λ1-λ3.

Tap routing device 435 is notified of available upstream data packets as they arrive, by each tap multiplexer 440. The tap routing device 435 is connected to each tap multiplexer 440 to receive these upstream data packets. The tap routing device 435 relays the packets to the data service hub 110 via the optical waveguide transceiver 430. The tap routing device 435 can build a lookup table from these upstream data packets coming to it from all tap multiplexers 440 (or ports), by reading the source IP address of each packet, and associating it with the tap multiplexer 440 through which it came. This lookup table can then used to route packets in the downstream path. As each packet comes in from the optical waveguide transceiver 430, the tap routing device 435 looks at the destination IP address (which is the same as the source IP address for the upstream packets). From the lookup table the tap routing device 435 can determine which port is connected to that IP address, so it sends the packet to that port. This can be described as a normal layer 3 router function as is understood by those skilled in the art.

The tap routing device 435 can assign multiple subscribers to a single port. More specifically, the tap routing device 435 can service groups of subscribers with corresponding respective, single ports. The optical taps 130 coupled to respective tap multiplexer 440 can supply downstream optical signals to pre-assigned groups of subscribers who receive the downstream optical signals with the subscriber optical interfaces 140.

In other words, the tap routing device 435 can determine which tap multiplexers 440 is to receive a downstream electrical signal, or identify which of a plurality of optical taps 130 propagated an upstream optical signal (that is converted to an electrical signal). The tap routing device 435 can format data and implement the protocol required to send and receive data from each individual subscriber connected to a respective optical tap 130. The tap routing device 435 can comprise a computer or a hardwired apparatus that executes a program defining a protocol for communications with groups of subscribers assigned to individual ports. One exemplary embodiment of the program defining the protocol is discussed in copending and commonly assigned non-provisional patent application entitled, “Method and System for Processing Downstream Packets of an Optical Network”, filed Oct. 26, 2001, and assigned U.S. application Ser. No. 10/045,652, the entire contents of which are incorporated by reference. Another exemplary embodiment of the program defining the protocol is discussed in commonly assigned non-provisional patent application entitled, “Method and System for Processing Upstream Packets of an Optical Network”, filed Oct. 26, 2001, and assigned U.S. application Ser. No. 10/045,584, the entire contents of which are incorporated by reference.

The single ports of the tap routing device 435 are connected to respective tap multiplexers 440. With the tap routing device 435, the laser transceiver node 120 can adjust a subscriber's bandwidth on a subscription basis or on an as-needed or demand basis. The laser transceiver node 120 via the tap routing device 435 can offer data bandwidth to subscribers in pre-assigned increments. For example, the laser transceiver node 120 via the tap routing device 435 can offer a particular subscriber or groups of subscribers bandwidth in units of 1, 2, 5, 10, 20, 50, 100, 200, and 450 Megabits per second (Mb/s). Those skilled in the art will appreciate that other subscriber bandwidth units are not beyond the scope of the invention.

Electrical signals are communicated between the tap routing device 435 and respective tap multiplexers 440. The tap multiplexers 440 propagate optical signals to and from various groupings of subscribers. Each tap multiplexer 440 is connected to a respective optical transmitter 325C. As noted above, each optical transmitter 325 can comprise one of a Fabry-Perot (F-P) laser, a distributed feedback laser (DFB), or a Vertical Cavity Surface Emitting Laser (VCSEL). The optical transmitters 325C produce the downstream optical signals at the third wavelength of λ3 that are propagated towards the subscriber optical interfaces 140. Each tap multiplexer 440 is also coupled to an optical receiver 370. Each optical receiver 370, as noted above, can comprise photoreceptors or photodiodes. Since the optical transmitters 325 and optical receivers 370 can comprise off-the-shelf hardware to generate and receive respective optical signals, the laser transceiver node 120 lends itself to efficient upgrading and maintenance to provide significantly increased data rates.

Each optical transmitter 325C and each optical receiver 370 are connected to a respective bi-directional splitter 360. Each bi-directional splitter 360 in turn is connected to a diplexer 420 which combines the unidirectional optical signals received from the splitter 415 that has the satellite TV-band and cable TV-band optical signals (having the first and second wavelengths of λ1, λ2) with the downstream optical signals (having the third wavelength λ3) received from respective optical transmitters 325.

In this way, broadcast video services as well as data services can be supplied with a single optical waveguide such as a distribution optical waveguide 150 as illustrated in FIG. 2. In other words, optical signals can be coupled from each respective diplexer 420 to a combined signal input/output port 445 that is connected to a respective distribution optical waveguide 150.

Unlike the conventional art, the laser transceiver node 120 does not employ a conventional router. The components of the laser transceiver node 120 can be disposed within a compact electronic packaging volume. For example, the laser transceiver node 120 can be designed to hang on a strand or fit in a pedestal similar to conventional cable TV equipment that is placed within the “last,” mile or subscriber proximate portions of a network. It is noted that the term, “last mile,” is a generic term often used to describe the last portion of an optical network that connects to subscribers.

Also because the optical tap routing device 435 is not a conventional router, it does not require active temperature controlling devices to maintain the operating environment at a specific temperature. In other words, the laser transceiver node 120 can operate in a temperature range between minus 40 degrees Celsius to 60 degrees Celsius in one exemplary embodiment.

While the laser transceiver node 120 does not comprise active temperature controlling devices that consume power to maintain temperature of the laser transceiver node 120 at a single temperature, the laser transceiver node 120 can comprise one or more passive temperature controlling devices 450 that do not consume power. The passive temperature controlling devices 450 can comprise one or more heat sinks or heat pipes that remove heat from the laser transceiver node 120. Those skilled in the art will appreciate that the invention is not limited to these exemplary passive temperature controlling devices. Further, those skilled in the art will also appreciate the invention is not limited to the exemplary operating temperature range disclosed. With appropriate passive temperature controlling devices 450, the operating temperature range of the laser transceiver node 120 can be reduced or expanded.

In addition to the laser transceiver node's 120 ability to withstand harsh outdoor environmental conditions, the laser transceiver node 120 can also provide high speed symmetrical data transmissions. In other words, the laser transceiver node 120 can propagate the same bit rates downstream and upstream to and from a network subscriber. This is yet another advantage over conventional networks, which typically cannot support symmetrical data transmissions as discussed in the background section above. Further, the laser transceiver node 120 can also serve a large number of subscribers while reducing the number of connections at both the data service hub 110 and the laser transceiver node 120 itself.

The laser transceiver node 120 also lends itself to efficient upgrading that can be performed entirely on the network side or data service hub 110 side. That is, upgrades to the hardware forming the laser transceiver node 120 can take place in locations between and within the data service hub 110 and the laser transceiver node 120. This means that the subscriber side of the network (from distribution optical waveguides 150 to the subscriber optical interfaces 140) can be left entirely in-tact during an upgrade to the laser transceiver node 120 or data service hub 110 or both.

The following is provided as an example of an upgrade that can be employed utilizing the principles of the invention. In one exemplary embodiment of the invention, the subscriber side of the laser transceiver node 120 can service six groups of 16 subscribers each for a total of up to 96 subscribers. Each group of 16 subscribers can share a data path of about 450 Mb/s speed. Six of these paths represents a total speed of 6×450=2.7 Gb/s. In the most basic form, the data communications path between the laser transceiver node 120 and the data service hub 110 can operate at 1 Gb/s. Thus, while the data path to subscribers can support up to 2.7 Gb/s, the data path to the network can only support 1 Gb/s. This means that not all of the subscriber bandwidth is useable. This is not normally a problem due to the statistical nature of bandwidth usage.

An upgrade could be to increase the 1 Gb/s data path speed between the laser transceiver node 120 and the data service hub 110. This may be done by adding more 1 Gb/s data paths. Adding one more path would increase the data rate to 2 Gb/s, approaching the total subscriber-side data rate. A third data path would allow the network-side data rate to exceed the subscriber-side data rate. In other exemplary embodiments, the data rate on one link could rise from 1 Gb/s to 2 Gb/s then to 10 Gb/s, so when this happens, a link can be upgraded without adding more optical links.

The additional data paths (bandwidth) may be achieved by any of the methods known to those skilled in the art. It may be accomplished by using a plurality of optical waveguide transceivers 430 operating over a plurality of optical waveguides, or they can operate over one optical waveguide at a plurality of wavelengths, or it may be that higher speed optical waveguide transceivers 430 could be used as shown above. Thus, by upgrading the laser transceiver node 120 and the data service hub 110 to operate with more than a single 1 Gb/s link, a system upgrade is effected without having to make changes at the subscribers premises.

Referring now to FIG. 5, this Figure is a functional block diagram illustrating an optical tap 130 connected to a subscriber optical interface 140 by a single optical waveguide 150 according to one exemplary embodiment of the invention. The optical tap 130 can comprise a combined signal input/output port that is connected to another distribution optical waveguide that is connected to a laser transceiver node 120. As noted above, the optical tap 130 can comprise an optical splitter 510 that can be a 4-way or 8-way optical splitter. Other optical taps having fewer or more than 4-way or 8-way splits are not beyond the scope of the invention. The optical tap 130 can divide downstream optical signals to serve respective subscriber optical interfaces 140. In the exemplary embodiment in which the optical tap 130 comprises a 4-way optical tap, such an optical tap can be of the pass-through type, meaning that a portion of the downstream optical signals is extracted or divided to serve a 4-way splitter contained therein, while the rest of the optical energy is passed further downstream to other distribution optical waveguides 150.

The optical tap 130 is an efficient coupler that can communicate optical signals between the laser transceiver node 120 and a respective subscriber optical interface 140. Optical taps 130 can be cascaded, or they can be connected in a star architecture from the laser transceiver node 120. As discussed above, the optical tap 130 can also route signals to other optical taps that are downstream relative to a respective optical tap 130.

The optical tap 130 can also connect to a limited or small number of optical waveguides so that high concentrations of optical waveguides are not present at any particular laser transceiver node 120. In other words, in one exemplary embodiment, the optical tap can connect to a limited number of optical waveguides 150 at a point remote from the laser transceiver node 120 so that high concentrations of optical waveguides 150 at a laser transceiver node can be avoided. However, those skilled in the art will appreciate that the optical tap 130 can be incorporated within the laser transceiver node 120.

The subscriber optical interface 140 functions to convert downstream optical signals received from the optical tap 130 into the electrical domain that can be processed with appropriate communication devices. The subscriber optical interface 140 further functions to convert upstream electrical signals into upstream optical signals of the third wavelength λ3 that can be propagated along a distribution optical waveguide 150 to the optical tap 130.

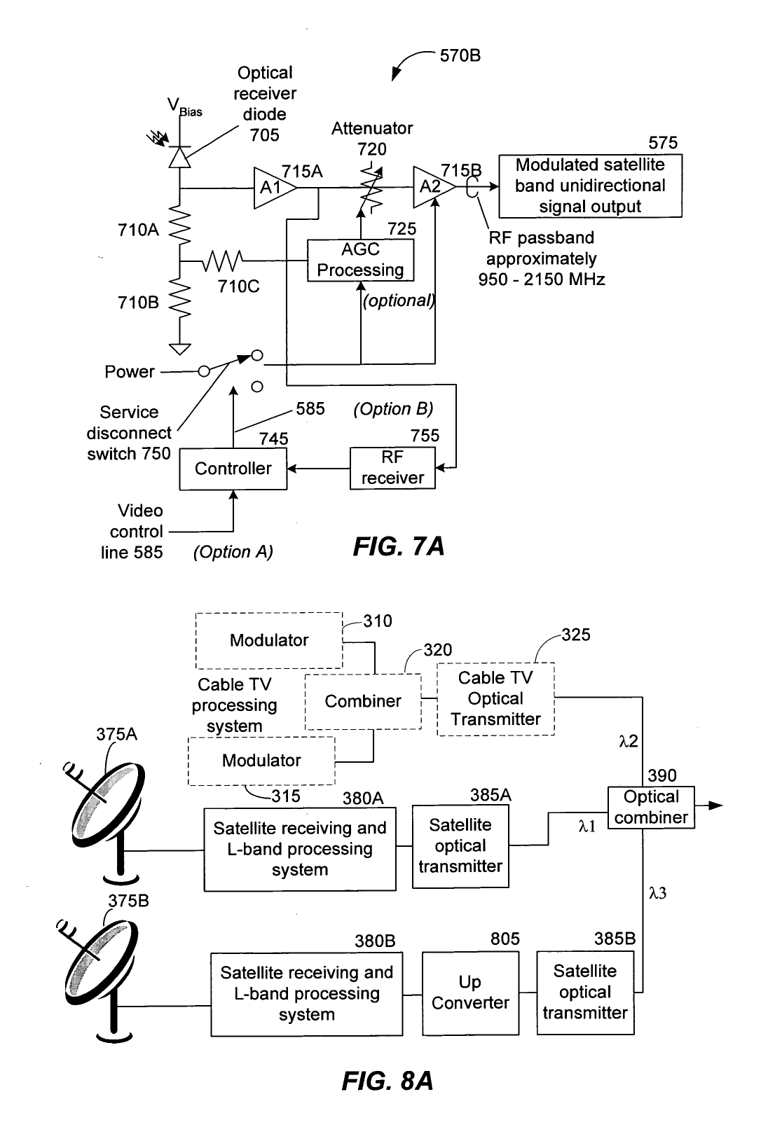

The subscriber optical interface 140 can comprise a satellite interface module 580. The satellite interface module 580 can comprise an optical filter 565, a satellite analog optical receiver 570, and a modulated satellite intermediate frequency (IF) band unidirectional signal output port 575. The optical filter 565 can receive the satellite TV-band, cable TV-band, and data optical signals having the first, second, and third optical wavelengths respectively (λ1, λ2, λ3) through port 1. The optical filter 565 can separate the satellite TV-band optical signals having the first wavelength λ1 from the cable TV-band optical signals of the second wavelength λ2 and the data optical signals of the third wavelength λ3. The cable TV-band and data signals exit the optical filter through the second port 2 while the satellite TV-band optical signals exit the optical filter 570 through the third port 3. Further details of the optical filter 570 will be discussed below with respect to FIG. 6.

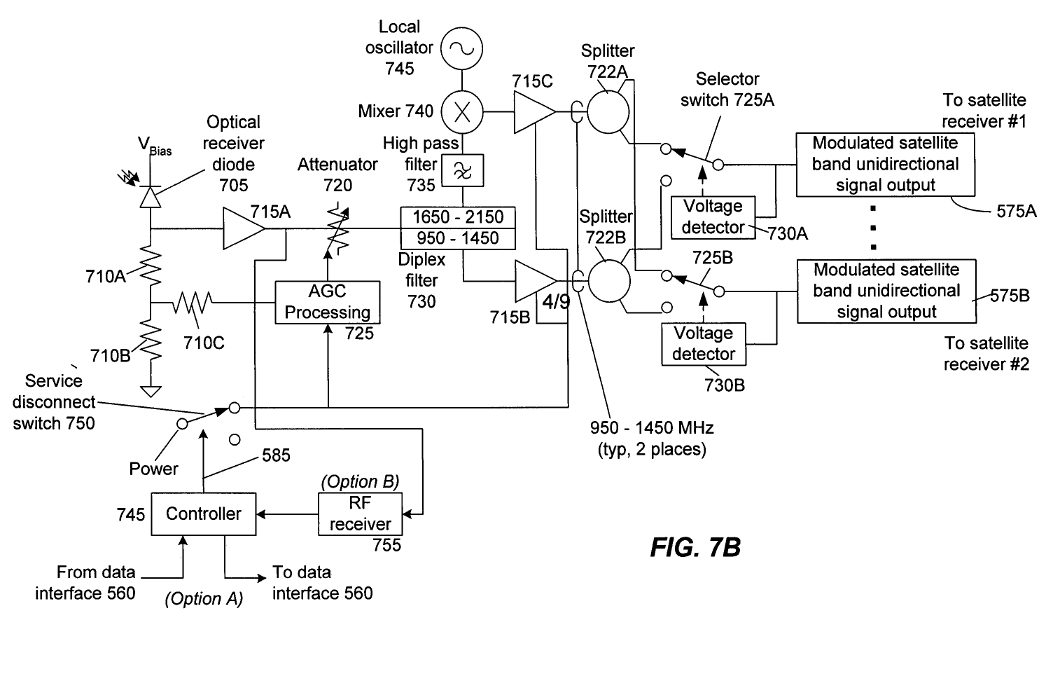

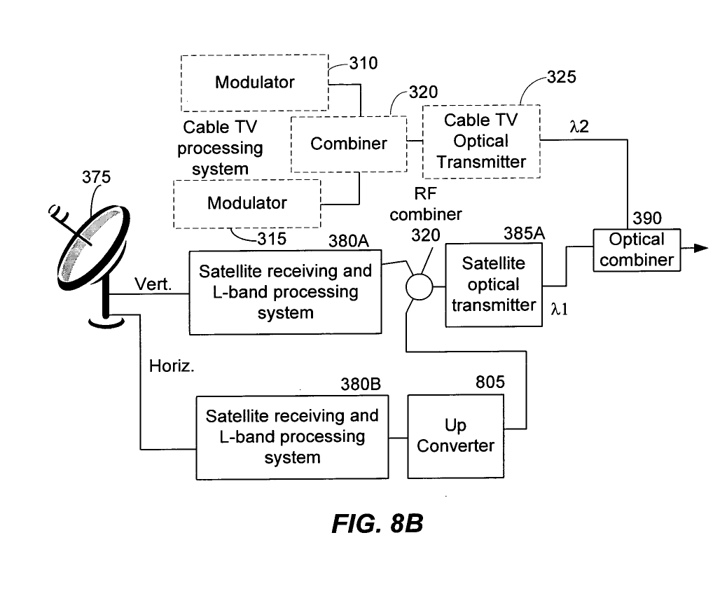

The satellite TV-band optical signals having the first wavelength λ1 can be processed and converted into the electrical domain with the satellite analog optical receiver 570. Further details of the satellite analog optical receiver 570 will be discussed below with respect to FIGS. 7-8. The satellite analog optical receiver 570 can process analog modulated RF transmissions as well as digitally modulated RF transmissions for digital TV applications. The electrical satellite TV-band signals are then provided to the modulated satellite IF band unidirectional signal output port 575. The modulated satellite IF band unidirectional signal output port 575 can feed RF receivers such as television sets (not shown) or radios (not shown).

The satellite analog optical receiver 570 can be controlled by a processor 550 that is coupled to the satellite analog optical receiver 570 by a video control line 585. The video control line 585 can send signals to enable or disable the satellite analog optical receiver 570. In this way, an operator of the data service hub 110 can control access to satellite TV services by a subscriber who uses the subscriber optical interface 140.

According to one exemplary embodiment, the satellite interface module 580 can comprise a single unit that is added in front of existing architecture in the subscriber optical interface 140. In this way, the satellite interface module 580 can be added to subscriber optical interfaces 140 that are already located or deployed at a subscriber's premises.

In addition to the satellite interface module 580, the subscriber optical interface 140 can comprise an optical diplexer 515 that divides the downstream optical signals comprising the cable TV-band optical signals at the second wavelength λ2 and data signals at the third wavelength λ3 received from the optical filter 565 between a bidirectional optical signal splitter 520 and an analog optical receiver 525. The optical diplexer 515 can receive upstream optical signals at the third wavelength λ3 generated by a digital optical transmitter 530. The digital optical transmitter 530 converts electrical binary/digital signals to optical form at the third optical wavelength λ3 so that the optical signals can be transmitted back to the data service hub 110. Conversely, the digital optical receiver 540 converts the optical data signals of the third wavelength λ3 into electrical binary/digital signals so that the electrical signals can be handled by processor 550.

The invention can propagate the optical signals at various wavelengths. However, the wavelength regions discussed are practical and are only illustrative of exemplary embodiments. Those skilled in the art will appreciate that other wavelengths that are either higher or lower than or between the 1310 and 1550 nm wavelength regions are not beyond the scope of the invention.

The analog optical receiver 525 can convert the downstream broadcast optical video signals, or the cable TV-band signals, into modulated RF television signals that are propagated out of the modulated RF unidirectional signal output 535. The modulated RF unidirectional signal output 535 can feed to RF receivers such as television sets (not shown) or radios (not shown). The analog optical receiver 525 can process analog modulated RF transmission as well as digitally modulated RF transmissions for digital TV applications.

The bi-directional optical signal splitter 520 can propagate combined optical signals in their respective directions. That is, downstream optical signals entering the bidirectional optical splitter 520 from the optical the optical diplexer 515, are propagated to the digital optical receiver 540. Upstream optical signals entering it from the digital optical transmitter 530 are sent to optical diplexer 515 and then to optical tap 130. The bi-directional optical signal splitter 520 is connected to a digital optical receiver 540 that converts downstream data optical signals into the electrical domain. Meanwhile the bi-directional optical signal splitter 520 is also connected to a digital optical transmitter 530 that converts upstream electrical signals into the optical domain.

The digital optical receiver 540 can comprise one or more photoreceptors or photodiodes that convert optical signals into the electrical domain. The digital optical transmitter can comprise one or more lasers such as the Fabry-Perot (F-P) Lasers, distributed feedback lasers, and Vertical Cavity Surface Emitting Lasers (VCSELs).

The digital optical receiver 540 and digital optical transmitter 530 are connected to the processor 550 that selects data intended for the instant subscriber optical interface 140 based upon an embedded address. The data handled by the processor 550 can comprise one or more of telephony and data services such as an Internet service. As noted above, the processor 550 can also enable or disable the satellite analog optical receiver 570 by sending control signals through the video control lines.

The processor 550 is also connected to a telephone input/output 555 that can comprise an analog interface. The processor 550 is also connected to a data interface 560 that can provide a link to computer devices, set top boxes, ISDN phones, and other like devices. Alternatively, the data interface 560 can comprise an interface to a Voice over Internet Protocol (VoIP) telephone or Ethernet telephone. The data interface 560 can comprise one of Ethernet's (10 BaseT, 100 BaseT, Gigabit) interface, HPNA interface, a universal serial bus (USB) an IEEE1394 interface, an ADSL interface, and other like interfaces.

Referring now to FIGS. 6A-6B, FIG. 6A illustrates the optical filter 565 in more detail while FIG. 6B illustrates the passband optical wavelengths for the various ports of the optical filter 565. Optical filter 565 comprises an optical bandpass filter 605 and an optical band skip wavelength division multiplexing (WDM) filter 610. These two filters 605, 610 may be discrete physical components, or in a preferred yet exemplary embodiment, they are combined into a single component or physical structure.

The bandpass filter 605 is connected between ports 1 and 3 of the optical filter 565. The bandpass filter 605 can be designed to select the satellite transmission optical wavelength region 615 for transmission to the satellite analog optical receiver 570. According to one exemplary embodiment, an optical wavelength 620 that can be passed in this region is one that is approximately 1542 nanometers. Those of ordinary skill in the art recognize that other optical wavelengths that can be passed by the satellite transmission optical wavelength region 615 are not beyond the scope of the invention.

The band skip WDM filter 610 is connected between ports 1 and 2 of the optical filter 565. It has two passband optical wavelength regions 625A, 625B with a stop band optical wavelength region 630 in the middle. The first passband optical wavelength region 620A passes the data transmission optical wavelength 635 and the second passband optical wavelength region 620B passes the cable TV-band transmission optical wavelength 640. According to one exemplary embodiment, the data transmission optical wavelength region can be approximately 1310 nanometers while the cable TV-band transmission wavelength region can be approximately 1557 nanometers. Those of ordinary skill in the art recognize that other wavelengths that can be within the two passband optical wavelength regions 625A, 625B are not beyond the scope of the invention.

The band skip stop band wavelength region 630 can include the satellite transmission wavelength 620. The satellite transmission wavelength 620 is not to be passed to port 2 of the optical filter 565.

Exemplary off-the-shelf filters that can enable the implementation of the optical filter 565 are available, though designed for a different purpose. One example is the FTTP 1310/1490/1550 Filter WDMs produced by Alliance Fiber Optic Products. This product was developed and specified for a different application, namely the three-wavelength plan promoted by the FSAN and 802.1ah standards. But the product may easily be modified for use with the teachings described above for the optical filter 365. Other suitable products are manufactured by Dicon and Fibernet, and are generically known as band skip WDMs, combined with a bandpass optical filter. Such components are known to those of ordinary skill in the art.

Referring now to FIG. 7A, this figure is a functional block diagram illustrating an exemplary satellite analog optical receiver 570A with a large frequency passband with two optional service controls according to an exemplary embodiment of the invention. The optical receiver 570A comprises an optical receiver diode 705 that receives the optical signal from port 3 of optical filter 365.

The optical signal is converted into an electrical current that is derived from the RF signals that were modulated onto an optical carrier, which current in turn produces a voltage across resistors 710A and 710B. The RF signal is amplified and converted to a lower impedance in amplifier 715A. An attenuator 720 adjusts the amount of signal reaching output amplifier 715B and is responsive to signals sent from an automatic gain control (AGC) processing circuit 725. The operation of the AGC processing circuit 725 will be explained in further detail below. The AGC processing circuit 725 is not essential to the optical receiver 570A and it can be omitted in some embodiments. The signal from attenuator 720 is supplied to output amplifier 715B, which in turn supplies the output signal to modulated satellite band unidirectional signal output 575.

There are several ways to arrange the AGC processing circuit 725 when it is used. A voltage representing the received optical level is developed across resistor 710B. This voltage is coupled through isolation resistor 710C to the AGC processing circuit 725, which compares the voltage against a reference, as is understood by those of ordinary skill in the art. The output of AGC processing circuit 725 controls attenuator 720 such that the output RF signal level on the modulated satellite band unidirectional signal output 575 is approximately constant regardless of the input optical signal level.

Since a subscriber with the satellite interface module 580 may decide to cancel satellite service, it is necessary to command the satellite analog optical receiver 570 to turn off, using a signal sent from the data service hub 110. Two methods are illustrated in FIG. 7A to send this command.

The first method characterized in the drawings as “Option A” comprises a video control line 585 from the processor 550 in the subscriber optical interface 140 (see FIG. 5). This control line 585 supplies signals to a controller 745. The controller 745 opens a service disconnect switch 750 when so commanded. This video control line 585 can comprise a two-level voltage: one level that commands the satellite analog optical receiver 570 to be “on” for supplying satellite signals, and the other commands is to be “off”. However, such a two-level control system can be susceptible to cheating by the subscriber.

A preferred and second exemplary embodiment for the service disconnect method for “Option A” comprises a serial data communications on the video control line 585. Furthermore, in order to avoid modifying an existing subscriber optical interface 140, it is preferable to configure video control line 585 as being a port that is compatible with the data interface 560, so that a cable from the satellite interface module 580 can be plugged into the data interface 560. This feature of being able to plug into the data interface 560 can eliminate the need for a separate video control line that is coupled directly to the processor 550 as illustrated in FIG. 5.

In a preferred embodiment, the data interface 560 comprises a plurality of Ethernet 10/100 Base-T ports which are well-known to those skilled in the art. In this case, the video control line 585 may comprise an Ethernet connection to the Data Interface 560. With an Ethernet connection or similar control design for the video control line 585, it is possible to provide for good security across the interface module 580, in order to prevent a subscriber from canceling service and then cheating by supplying his own signal to turn the satellite analog optical receiver 570 back on.

There are many ways to implement security measures with the “Option A” design. A preferred embodiment would be to give both the processor 550 and the satellite analog optical receiver 570 digital signatures that could be checked prior to issuing or responding to, a command to turn the satellite service “on.” Usually, turning the satellite TV-band service off is not as critical, as one may assume that a subscriber will not cheat and turn off service for which he is paying. One exemplary technique is the use of X.509 certificates, which are well understood by those of ordinary skill in the art.

A preferred and alternate exemplary embodiment is one that lets the satellite interface module 580 stand alone or work independently without active control from the existing subscriber optical interface 140 so that no communications are needed between the two units. However, powering the satellite interface module 580 may still be supplied from subscriber optical interface 140, depending on the particular design. These stand alone security embodiments are characterized as “Option B” in FIG. 7A.

Under “Option B”, any need to modify the existing subscriber optical interface 140 or to use an existing interface port can be eliminated. “Option B” can comprise an RF receiver 755 connected to the output of the preamplifier 715 so that it can receive a signal on a separate RF carrier used to send messages to the controller 745. This separate RF carrier can comprise low cost, low data rate modulation such as frequency shift keying (FSK), which is well-known to those of ordinary skill in the art. A signal may be sent to individual satellite analog optical receivers 570, telling them to either turn on or turn off.

A simple method of using RF carrier signals under “Option B” comprises assigning each receiver 570 a unique address. The address is then cross-referenced with a subscriber database. When a change in states is desired, a transmission is made that bears the address of the device 570, along with instruction to turn on or off. This method works, but leaves open the possibility of pirating the satellite TV-band service by turning on a receiver 570 by a subscriber who is not paying for service.

A method of preventing pirating of the satellite TV-band service comprises storing a secret address within each receiver 570. This secret address should never be publicly disclosed to people outside of the organization in charge of the satellite TV-band services. A table can be made at manufacture that cross indexes a public serial number with the secret address. So long as an operator of the optical network has the table, he will know how to address each receiver 570.

This secret address method also works, but it can have some drawbacks. As satellite analog optical receivers 570 are moved from one location to another, the table that cross indexes the public serial number and secret address must be transferred with the receiver 570. If the table is ever lost or corrupted, the receiver 570 could be rendered unusable. This problem can be mitigated by having the manufacturer of the receiver 570 keep a perpetual data base, which can be accessed by the purchaser of the receiver 570 upon presentation of valid credentials such as an electronic signature.

For example, the receiver manufacturer could maintain a database that is accessible over the Internet and an owner of the receiver could be granted access to this database by using known signature technology such as X.509 certification. If the ownership of a receiver 570 changes, then the new owner must be registered with the manufacturer before he can access the secret address of the receiver 570.

Several alternatives exist for disconnecting satellite TV-band service at the receiver 570 under both Option A and Option B. Power may be removed to output amplifier 715B. Alternatively, attenuator 720 may be driven to it's maximum attenuation state. If Option A is used to communicate control, power may be removed from preamplifier 715A (removal of power from preamplifier is not shown in the FIG. 7A).

When the output amplifier 715B is enabled to establish satellite TV-band service for a subscriber, and particularly with Option B that can require communicating turn-on and turn-off information, it is preferable to configure Controller 745 such that it must periodically receive a keep-alive command from the Data Service Hub 110. Otherwise, it is possible for a subscriber to pirate satellite TV-band service by removing the Video Control Line(s) 585. Disconnecting Video Control Line 585 after the controller 745 has received a turn on command, could prevent Controller 745 from receiving a turn-off signal. But if the controller 745 is configured to require a keep-alive signal, and if the Video Control Line(s) 585 are removed, then the satellite TV-band service would be disconnected in a short time when the controller 745 starts searching for the keep-alive signal.

If Option B is used, then the preamplifier 715A must be provided with power. The preamplifier 715 must be provided with continuous power because it is needed to receive a turn-on command. Other methods for removing signal output or disabling the satellite optical receiver 570 are not beyond the scope of the invention.

Referring now to FIG. 7B, this figure is a functional block diagram illustrating an exemplary satellite analog optical receiver 570B with two optional service controls in addition to a polarization switch 725 according to an alternate exemplary embodiment of the invention. The receiver 570B illustrated in FIG. 7B does have some structure similar to the receiver 570A illustrated in FIG. 7A. Therefore, only the differences between the two receivers 570A, 570B will be described below.

One main difference between the first receiver 570A illustrated in FIG. 7A and the second receiver 570B illustrated in FIG. 7B is that the first receiver 570A of FIG. 7A is intended to process satellite TV-band signals of a single frequency band that comprises two polarities of signals being transmitted from the satellite. It is common in satellite communications, to use the same frequencies for two downlink signals in order to conserve spectrum. This is accomplished by sending different signals on each of two RF polarities coming from the satellite to the receiving antenna. This technique is well-known to those of ordinary skill in the art.

For example, with direct broadcast satellite (DBS) satellites in North America, it is common practice to transmit one half of the signals using vertical polarization, and the other half on the same frequencies but using a horizontal polarization. In some other regions such as Europe, right-hand and left-hand circular polarizations are used. Either polarization technique provides satisfactory performance.

Since there is no practical equivalent to polarization in the optical domain, another technique must be used send all of the transmitted satellite TV-band signals to subscribers. In the second receiver 570B illustrated in FIG. 7B, it is assumed that at the downlink receive point usually but not necessarily at the Data Service Hub 110, the two polarizations are frequency translated into different frequency bands. For example, vertical polarization signals may be translated to the 950-1450 MHz spectrum while horizontal polarization signals may be translated to 1650-2150 MHz.

It is assumed that the output is capable of handling the entire frequency band, as illustrated in FIG. 6. It is further assumed that the satellite receiver 570 connected to the modulated satellite band unidirectional signal output 575 is capable of receiving this entire frequency band.

In some satellite systems, the receivers 570 are designed for the two polarizations. And therefore, they cannot receive the entire 950-2150 MHz frequency band. These receivers 570 typically send signals to the low noise down-converter on the satellite dish antenna 375, telling the low noise down converter which polarity to select and send to the receiver 570.

For such selectable polarization receiver systems, some modifications to the receiver 570A illustrated in FIG. 7A are needed. These modifications are illustrated in FIG. 7B. The RF receiver 570B of FIG. 7B, except for output amplifier 715B, is identical to FIG. 7A. A diplex filter 730 can be added after the attenuator 720 in order to separate the two satellite frequency bands.

The lower frequency band is usually 950-1450 MHz is passed through the diplexer 730 to amplifier 715B. The higher frequency band, 1650-2150 for example, is transmitted through the diplexer filter 730 to a high pass filter 735. In some instance, the high pass filter 735 may not be necessary depending on the performance of diplex filter 735.

From the High Pass Filter 735, the 1650-2150 MHz band signal is propagated to a mixer 740 whose other input is from local oscillator 745. The frequency of the local oscillator 745 usually must be selected to not change the phase sense of the modulation. This issue is understood by those of ordinary skill in the art. The output of mixer 740 is in the 950-1450 MHz band, the same as the signal that passed through to amplifier 715B. This downconverted signal that is output from the mixer 740 is amplified in amplifier 715C. The signal is then applied to splitter 722A.

The original, unconverted 950-1450 signal is amplified in amplifier 715B and passes to splitter 722B. Selector switches 725A, 725B at the output of the splitters 722A, 722B, permit supplying either set of signals to any of a plurality of receivers through a plurality of modulated satellite band unidirectional signal outputs, 575A, 575B. As is understood by those of ordinary skill in the art, each satellite receiver (not shown) typically uses a voltage that commands the low noise block converter (LNB) in the satellite receiving antenna 375 to change polarities.

The satellite analog optical receiver 570B can use this voltage by looking for it with voltage detectors 730A and 730B to control selector switches 725A and 725B in order to select the correct set of signals for each receiver (not shown) coupled to a respective modulated satellite band unidirectional signal output port 575A, 575B.

Referring now to FIG. 8A, this figure is a functional block diagram illustrating an alternate exemplary embodiment of a portion of a data service hub 110 in which two or more satellite RF receiving and L-band processing systems 380A, 380B are used to generate two sets of optical signals of different wavelengths that can be combined with cable TV-band signals at another wavelength. This system can support satellite services from two or more satellite service providers, such as the Dish Network and Direct TV who are service providers at the time of the writing of this document.

The structure illustrated in FIG. 8A is substantially similar to the structure illustrated in FIG. 3. Only the differences between these two figures will be discussed. The second satellite receiving and L-band processing system 380B is coupled to an up converter 805 that can convert the output from the second satellite receiving and L-band processing system 380B to a frequency range that is higher than the output of the first satellite receiving and L-band processing system 380A. Alternatively (and not illustrated), the second satellite receiving and L-band processing system 380B can be coupled to a down converter (not illustrated) that can convert the output from the second satellite receiving and L-band processing system 380B to a frequency range that is lower than the output of the first satellite receiving and L-band processing system 380A.

The output from first satellite receiving and L-band processing system 380A can be used to modulate a first satellite optical transmitter 385A at a first optical wavelength. Meanwhile, the output of the RF combiner 320 can be used to modulate a cable TV-band optical transmitter 325 at a second optical wavelength. It is noted that the modulators 310, 315, RF combiner 320, and cable TV-band optical transmitter 325 are illustrated with dashed lines in FIG. 8 to indicate that these elements are optional. That is, according to one exemplary embodiment, the data service hub 110 does not comprise any modulators 310, 315, RF combiner 320, and cable TV-band optical transmitter 325 but the hub 110 can comprise one or more satellite antennas 375 and respective processing systems 380.

The output from second satellite receiving and L-band processing system 380B can be used to modulate a second satellite optical transmitter 385B at a third optical wavelength different from the first and second optical wavelengths. According to another exemplary embodiment, the first, second, and third optical wavelengths can be combined with data optical signals that are propagated using a fourth optical wavelength (not illustrated).

Referring now to FIG. 8B, this figure illustrates two polarities of satellite signals can be received from a single dish antenna 375. The system illustrated in FIG. 8B is substantially similar to the system illustrated in FIG. 8A. Only the differences between these two figures will be discussed. FIG. 8B illustrates a single satellite optical transmitter 385A for the satellite RF signals that are combined in an RF combiner 320 after one set is upconverted into a higher RF frequency range.

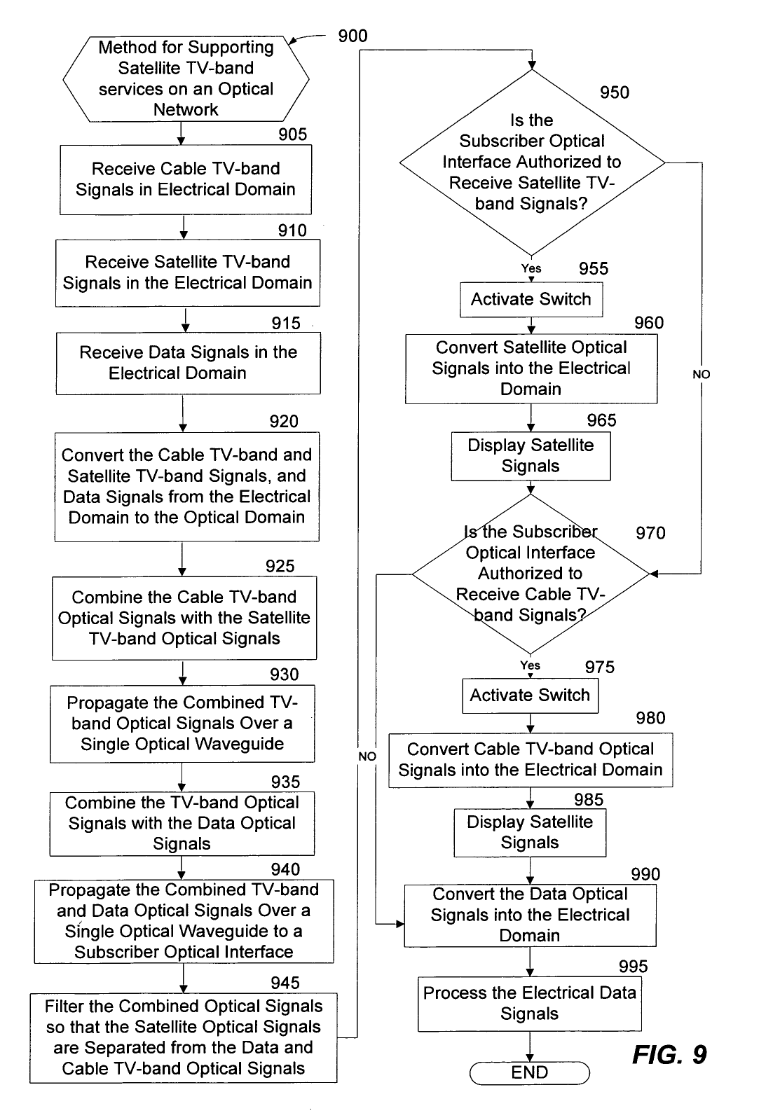

Referring now to FIG. 9, this figure is a logic flow diagram illustrating an exemplary method 900 for providing satellite TV-band video services over an optical network 100 according to one exemplary embodiment of the invention. Certain steps in the process described below must naturally precede others for the invention to function as described.

However, the invention is not limited to the order of the steps described if such order or sequence does not alter the functionality of the invention. That is, it is recognized that some steps may be performed before or after or in parallel with other steps without departing from the scope and spirit of the invention.

Step 905 is the first step in the exemplary satellite TV-band services method 900. In step 905, cable TV-band signals are received in the electrical domain. For example, the RF combiner 320 of FIG. 3 can receive cable TV-band signals from the modulators 310, 315.

In step 910, satellite TV-band signals can be received in the electrical domain. For example, satellite TV-band signals can be received from a satellite (not shown) with a satellite antenna 375 as illustrated in FIG. 3.

Next, in step 915, data signals can be received in the electrical domain. For example, the laser transceiver node routing device 355 can receive data signals originating from the Internet router 340 and the telephone switch 345 as illustrated in FIG. 3.

Subsequently, in step 920, the cable TV-band, satellite TV-band signals, and the data signals can be converted from the electrical domain to the optical domain. For the cable TV-band electrical signals, they can be converted into the electrical domain with the cable TV optical transmitter 325B as illustrated in FIG. 3. For the satellite TV-band signals, they can be converted from the electrical domain into the optical domain with the satellite optical transmitter 325A as illustrated in FIG. 3. The data signals from the laser transceiver node routing device 355 can be converted into the optical domain with respective optical transmitters 325C as illustrated in FIG. 3.

In step 925, the cable TV-band and satellite TV-band signals are combined. Specifically, these optical signals can be combined with the optical combiner 385 as illustrated in FIG. 3.

Next, in step 930, the combined TV optical signals can be propagated over a single optical waveguide. For example, the combined TV optical signals can be propagated over an optical waveguide 160 from the data service hub 110 to the laser transceiver node 120 as illustrated in FIG. 3.

Next, in step 935, the TV optical signals are combined with the data optical signals. For example, the satellite TV band optical signals and the cable TV-band optical signals having the first and second wavelengths λ1 and λ2 can be combined with the data optical signal having a third optical wavelength of λ3 as illustrated in FIG. 4. Specifically, the signals can be combined with respective diplexers 420 as illustrated in FIG. 4.

Then in Step 940, The combined TV and data optical signals can be propagated over a single optical waveguide to a subscriber optical interface 140. Specifically, the satellite TV-band optical signals, cable TV-band optical signals and data signals having first, second and third wavelengths respectively, can be propagated over a single optical waveguide 150 as illustrated in FIG. 1.

In step 945, the combined TV and data signals can be filtered so that the satellite TV-band optical signals are separated from the data and the cable TV-band optical signals. For example, the optical filter 565 as illustrated in FIG. 5 can separate the respective optical signals having different wavelengths.

In decision step 950, it is determined whether a particular subscriber optical interface 140 is authorized to receive satellite TV-band signals. In this step, one of several designs can be used to enable or disable the satellite analog optical receiver 570 as discussed above with respect to FIG. 7-8.

If the inquiry to decision step 950 is positive, then the “yes” branch is followed to step 955 in which a switch such as service disconnect switch 750 is activated. If the inquiry to decision step 950 is negative, then the “No” branch is followed to decision step 970.

In step 960, the satellite TV-band optical signals are then converted into the electrical domain with the satellite analog optical receiver 570. In step 965, the satellite TV-band signals can then be processed and displayed with a TV.

In decision step 970, it is determined whether a particular subscriber optical interface 140 is authorized to receive cable TV-band signals. If the inquiry to decision step 970 is positive, then the “yes” branch is followed to 975 in which a switch that controls cable TV-band services for a subscriber is activated. If the inquiry to decision step 970 is negative, then the “no” branch is followed to step 990. In step 980, the cable TV-band optical signals are converted into the electrical domain. Then, in step 985, the cable TV-band signals can then be processed and displayed with a TV.

In step 990, the data optical signals are converted into the electrical domain. And lastly, in step 995 electrical data signals can be handled or processed with the processor 550 as illustrated in FIG. 5.

It should be understood that the foregoing relates only to illustrate the embodiments of the invention, and that numerous changes may be made therein without departing from the scope and spirit of the invention as defined by the following claims.

What is claimed is:

1. A method for providing satellite TV-band signals and data services over an optical network comprising:
receiving the satellite TV-band signals from a satellite in an electrical domain;
receiving data signals in an electrical domain;
converting the satellite TV-band signals from the electrical domain to an optical domain at a first optical wavelength;
converting the data signals from the electrical domain to the optical domain at a second optical wavelength different from the first optical wavelength;
combining satellite TV-band optical signals with data optical signals for optical transmission;
separating the satellite TV-band optical signals from the data optical signals with an optical filter; and
converting the satellite TV-band optical signals from the optical domain to the electrical domain.

2. The method of claim 1, further comprising propagating the combined optical signals over a single optical waveguide.

3. The method of claim 1, further comprising combining satellite TV-band optical signals with cable TV-band optical signals prior to combining the satellite TV-band optical signals with the data optical signals.

4. The method of claim 1, wherein converting the satellite TV-band signals from an electrical domain to an optical domain at a first optical wavelength further comprises modulating an optical transmitter with the satellite TV-band signals.

5. The method of claim 1, wherein the data signals support at least one of telephony and computer services for a subscriber of the optical network.

6. The method of claim 1, wherein separating the satellite TV-band optical signals from the data optical signals with an optical filter further comprises filtering the satellite TV-band and cable TV-band optical signals with at least one of a bandpass filter and a band skip wavelength division multiplexer.

7. The method of claim 1, further comprising activating a switch to control access to the satellite TV-band signals.

8. The method of claim 1, further comprising monitoring a status of a switch to control access to the satellite TV-band signals.

9. A method for providing satellite TV-band signals and cable TV-band services over an optical network comprising:
receiving the satellite TV-band electrical signals from a satellite antenna;
converting the satellite TV-band electrical signals into optical signals comprising a first optical wavelength;
modulating an optical carrier of a second optical wavelength with cable TV-band signals to form satellite TV-band optical signals;
combining satellite TV-band optical signals with the cable TV-band optical signals for optical transmission;
removing the satellite TV-band optical signals from the cable TV-band optical signals with an optical filter; and
converting the satellite TV-band optical signals from the optical domain to the electrical domain.

10. The method of claim 9, further comprising propagating the combined optical signals over a single optical waveguide.

11. The method of claim 9, further comprising combining the satellite TV-band optical signals and the cable TV-band optical signals with the data optical signals.

12. The method of claim 9, further comprising propagating the combined satellite TV-band and cable TV-band optical signals over a single optical waveguide.

13. The method of claim 9, further comprising controlling access to the satellite TV-band services with a remotely controlled switch disposed in a subscriber optical interface.

14. A system for providing satellite TV-band signals and cable TV-band services over an optical network comprising:
a satellite interface module for converting satellite TV-band optical signals into electrical signals and for separating the satellite TV-band optical signals from downstream cable TV-band optical signals and data optical signals; and
a subscriber optical interface coupled to the satellite interface for receiving and processing the downstream cable TV-band optical signals and data optical signals.

15. The system of claim 14, wherein the satellite interface module comprises an optical filter for separating the satellite TV-band optical signals from cable TV-band optical signals and data optical signals.

16. The system of claim 14, wherein the subscriber optical interface comprises an optical diplexer that is coupled to the satellite interface module, the subscriber optical interface further comprising an analog optical receiver.

17. The system of claim 1, wherein the subscriber optical interface further comprises a processor that is coupled to a service disconnect switch.
